(19) United States
(12) Patent Application Publication
(10) Pub. No.: US 2009/0006537 A1
(43) Pub. Date: Jan. 1, 2009

(54) Virtual Desktop Integration with Terminal Services

(75) Inventors: Ashwin Palekar, Redmond, WA (US); David T. Dopson, Seattle, WA (US); Rouslan Beletski, Kenmore, WA (US); Ido Ben-Shachar, Kirkland, WA (US); Robert K. Leitman, Duvall, WA (US); Huei Chung Wang, Kirkland, WA (US); Sriram Sampath, Redmond, WA (US); Tad Dennis Brockway, Redmond, WA (US)

Correspondence Address: LEE & HAYES PLLC, 601 W Riverside Avenue, Suite 1400, SPOKANE, WA, 99201, US

(73) Assignee: MICROSOFT CORPORATION, Redmond, WA (US)

(21) Appl. No.: 11/771,921

(22) Filed: Jun. 29, 2007

(51) Int. Cl. G06F 15/16

(52) U.S. Cl. 709/203

(57) ABSTRACT

An integration system is disclosed that provides a virtual desktop integration with terminal services. A client computer is connected to one the virtual desktops operating in a server. The client computer examines information contained in a remote desktop protocol (RDP) compliant packet supplied by the server. The client computer connects to one of the many virtual desktops based on information. Use of the information enables integration of the virtual desktop with the existing terminal session deployment model. Client devices can establish a session using a single network name and can be appropriately directed to either a virtual desktop or terminal session.

### BACKGROUND

Terminal Services is a mature widely deployed server technology for remoting a desktop application. Terminal Services has feature-reach efficient remoting protocols (like remote desktop protocol (RDP)). Terminal services technology has a developed management, monitoring and licensing infrastructure. Also Terminal Services support both remote desktop and remote program applications.

Remote Desktop only remotes the “graphic presentation” of the desktop and application windows from a terminal server to a client computer, while remote programs remotes only the “graphic presentation” of the applications running on the terminal server, thus allowing a final desktop composition to occur in the client computer.

Both Remote Desktop and Remote Programs can help to achieve a “stateless desktop” goal; e.g. no state is stored on the client computer. However, Remote Desktop requires a total lockdown of a person's desktop (users typically can't install any applications or even ActiveX controls for their web-browsers) while Remote Programs support more flexibility—e.g. allowing an administrator to enable deployment of uncommon or even personal software on desktops while simultaneously deploying business critical applications on the terminal server.

One drawback Terminal Services (TS) technology is the fact that multiple copies of the same application must run simultaneously in multiple sessions. When applications are not properly written to support simultaneous users, “serving” multiple users breaks some applications. Specifically, if the particular application running on a Terminal Server stores the user's data in a common file name, then multiple copies of the application run by different users will overwrite each-other. This will result in most users' data being erased, while only the most recently written common file name will be used, and all users will inadvertently receive those settings.

Also a lack of resource isolation enforcement in the operating system (OS) allows any bad behaving (“run away”) application, which consumes 100% of CPU processing cycles or has leaking memory, to degrade the user experience for all other users connected to the same terminal server.

Further sessions can not be migrated from server to server making load balancing imperfect. Imperfect load balancing, in the event of a server hardware failure, may result in data loss of unsaved data for user's applications running on the terminal server.

Virtual Desktop Initiative (VDI) is an emerging technology that allows execution of a desktop OS on a server in datacenter and connects to it through a desktop remoting protocol from a stateless client. It addresses most of the Terminal Services disadvantages but has its own limitations:

For example, the initial VDI acquisition cost is higher because virtual machines have much higher memory and CPU requirements than running the same applications within a Terminal Server. This results in a significantly higher (10×) hardware cost. Further OS licensing requires that a retail copy of the client OS be purchased for each virtual machine.

The cost of ownership is also high because each individual OS copy must be managed whether it runs on a desktop or in datacenter. Specifically, when users each have their own virtual machine (VM) within a desktop, the administrator needs to administer/patch each VM image. In contrast, a Terminal Server that hosts multiple users has only one OS that needs to be patched.

Totally new connectivity mechanisms, administration and management infrastructure has to be deployed in each virtual machine. Finally existing VDI solutions don't offer Remote Program capabilities

For some applications that an administrator wants to deploy, a terminal server is sufficient if that set of applications work well within a Terminal Server (i.e. well-written multi-user applications). For other applications that have special requirements (such as poorly written multi-user applications), running them within VDI technology may be preferable. Thus, an administrator's ideal deployment may contain both terminal server hosted applications/desktops and applications hosted within VDI technology. However, deploying two different technologies with different connectivity, administration and licensing infrastructures may be problematic.

### SUMMARY

A hybrid TS/VDI-type (TSV) solution, which is fully integrated with (and based on) the Terminal Services infrastructure, is deployed. Once TSV is deployed, customers will use existing terminal services infrastructure to connect a client to a server. A simple and transparent user policy configuration will provide the parameters to connect the client to either a terminal services session or a “Virtual Desktop” session. Administrators will be able to use the same set of farm management tools for managing terminal services sessions and virtual desktop-sessions.

In one embodiment, an integration system is provided with a client computer is connected to one of many virtual desktops. The virtual desktops run on a server. A redirector token in a remote desktop protocol (RDP) compliant packet is examined by the client computer. Based on information contained in the redirector token, the client computer connects to one of the plurality of virtual desktops. A gateway may optionally be used to connect the client computer to the virtual desktop if the user connects from the Internet.

In another embodiment, the client computer connects to one of the virtual desktops using a session broker and a pool manager. The session broker is used to assign one of the virtual desktops to the client computer. The pool manager indicates which of the virtual desktops are available to be assigned.

Also, the gateway or other computing device is used to connect a remote desktop protocol (RDP) client computer to one the virtual desktops. The RDP client computer indicates a network name that is used to generate an internet protocol (IP) address to establish a virtual desktop session between the client computer and the one of the virtual desktops.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 illustrates an example integration system in which virtual desktops may be integrated with a terminal server for connecting with client devices.

FIG. 2 is a block diagram depicting selected modules in a client computer in the integration system.

FIG. 3 is a block diagram depicting selected modules in a Virtual Desktop in the integration system.

FIG. 4 illustrates a flow diagram of an exemplary process operating on a redirector/broker device for connecting and transferring content between a client device and the virtual desktop.

FIG. 5 illustrates a flow diagram of an exemplary process executed with a client device for connecting and transferring content between the client device and the virtual desktop.

FIG. 6 illustrates a flow diagram of an exemplary process executed with a server device for connecting and transferring content between the client device and the virtual desktop.

### DETAILED DESCRIPTION

### Overview

This disclosure is directed to a system that provides a virtual desktop integration with terminal services. In one embodiment a client computer is connected via a redirector/broker device to one the virtual desktops running on a server or a terminal server. The client computer examines a redirector token in a remote desktop protocol (RDP) compliant packet. The client computer connects to one of the many virtual desktops based on information contained in the redirector token. Use of the redirector token enables integration of the session hosted with one or more VMs (or terminal servers) with the existing terminal session deployment model. The client computer, using the token, can be appropriately directed to either a virtual desktop or terminal session.

In another embodiment, an RDP client computer is connected to one of the virtual desktops using a session broker and a pool manager. The session broker assigns the virtual desktops to the client computer when the client computers connected to a virtual desktop hosted on a VM, and the pool manager indicates which of the virtual desktops are available to be assigned. The session broker can be abstracted from code that creates and manages VM images on-the-fly. This abstraction can be achieved by extensibility points within the broker. Thus the virtual desktop hibernation and state transition may occur and be transparent to the RDP client.

In a further embodiment, the RDP client computer is connected to a virtual desktop. The RDP client computer indicates a network name that is used by the broker to generate an internet protocol (IP) address to establish connection between the client computer and the virtual desktops. By hiding the individual virtual desktop IP addresses from the RDP clients, only a single network name of the broker is initially required to be externally exposed to the terminal server clients.

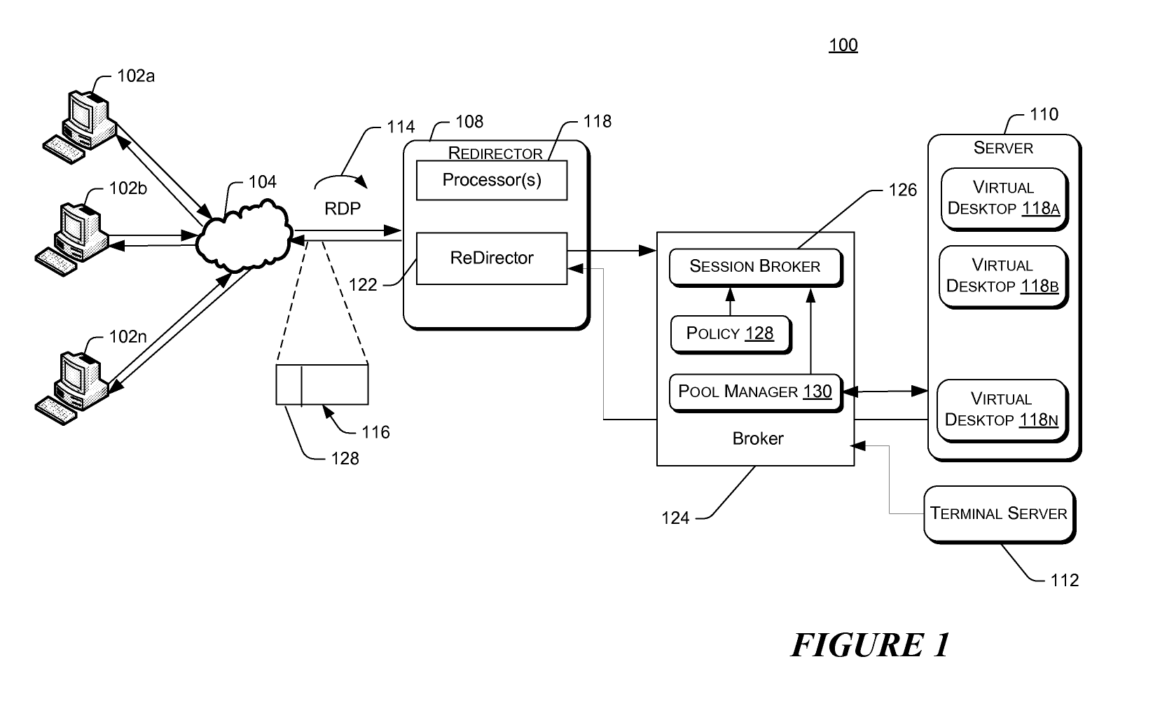

The construction of the virtual desktop and terminal services integration system and an environment in which this integration system may be enabled by techniques is set forth first below with reference to FIGS. 1-6. This is followed by others sections describing various inventive techniques and illustrative embodiments of other aspects of the integration system.

### Example System Architecture

FIG. 1 illustrates an example system 100 in which there is shown plurality of client devices 102(a-n) connected via network 104, redirector device 108 and broker 124 to virtual desktop server 110 and terminal server 112. In one embodiment, the redirector device 108 and the broker 124 are disposed on the same server. In another embodiment, a gateway (not shown) may be connected between redirector device 108 and network 104 or client devices 102(a-n).

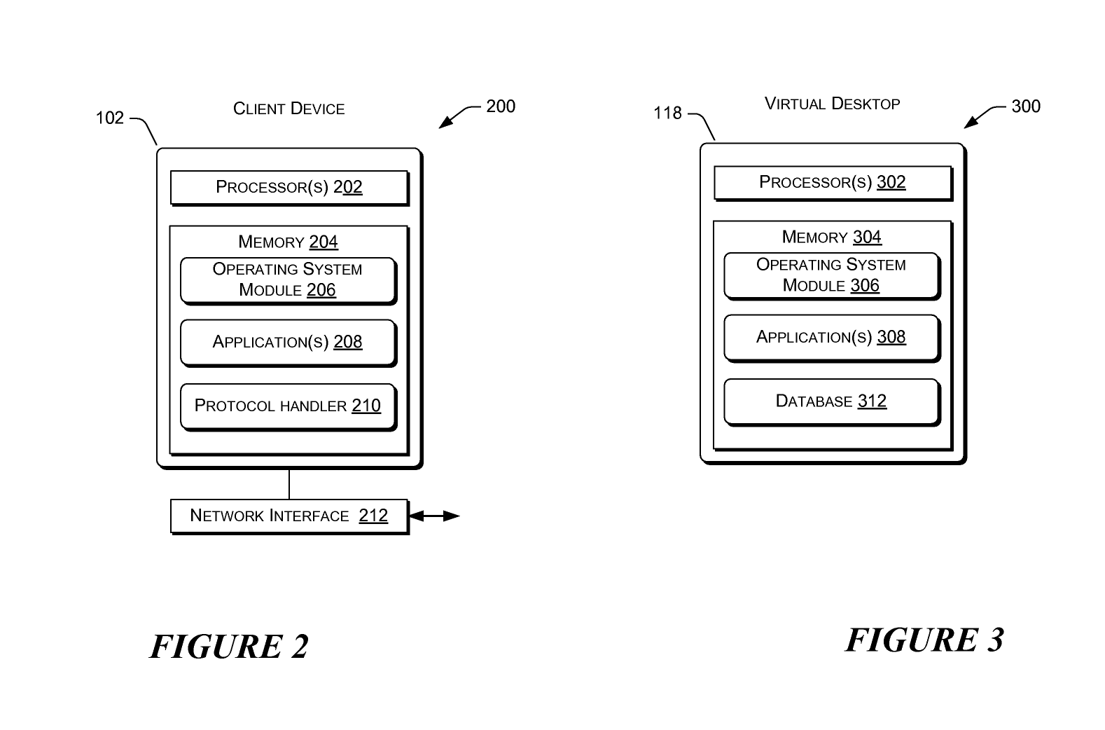

Client devices 102(a-n) may be any computing device capable of communicating with a network 104, and are also referred to as terminal services clients. In one embodiment, the client devices 102(a-n) are general purpose desktop computing devices assigned to users (e.g., employees) that are connected to the wired network 104. Although the illustrated client devices 102(a-n) are depicted as a desktop PC, the client devices may be implemented as any of a variety of conventional computing devices including, for example, a server, a notebook or portable computer, a workstation, a mainframe computer, a mobile communication device, a PDA, an entertainment device, a set-top box, an Internet appliance, a game console, and so forth. Further details of client devices 102(a-n) are discussed in FIG. 2.

In one embodiment, client devices 102(a-n) transmit requests for content, send content and receive content using an RDP protocol 114. Client devices 102(a-n) receive content in an RDP packet 116 format from redirector device 108.

Network 104 may be any type of communications network, such as a local area network, wide area network, cable network, the internet, the World Wide Web or a corporate enterprise network. Content is transmitted from and received by client devices 102(a-n) in a packetized format via network 104 for delivery to and from redirector device 108.

Redirector device 108 includes a processor 118 and memory 120. Included in memory (not shown) comprising a redirector module 122. Broker module 124 includes a session broker module 126, a policy module 128 and a pool manager module 130. Broker module 124 may be disposed in a server, such as server 110, may be disposed in a standalone server or may be disposed within redirector device 108.

Server 110 includes a plurality of virtual desktops 118(a-n), generally known as virtual machines. Although the illustrated virtual desktops 118(a-n) are shown as a blade within 110 server, the virtual desktops 118(a-n) may be individually implemented as any of a variety of conventional computing devices including, for example, a server, a notebook or portable computer, a workstation, a mainframe computer, a mobile communication device, a PDA, an entertainment device, a set-top box, an Internet appliance, a game console, and so forth. Further details of virtual desktops 118(a-n) are discussed in FIG. 3.

Redirector 122 receives RDP packets from clients 102(a-n) and incorporates those packets for delivery to broker module 124. Redirector 122 also transmits requests from broker module 124 to establish a connection between one of virtual desktops 118(a-n) and client devices 102(a-n). Such requests are received in broker 124 by session broker 126. Broker 124 also receives from server 110 an indication of which virtual desktops 118(a-n) are available.

Session broker 126 also receives a policy indication from policy module 128 indicating criteria for selection of virtual desktops 118(a-n). Session broker 126 then provides an indication to redirector 122 indicating which one of the virtual desktops 118(a-n) are available for connection to one of the client devices 102(a-n). In one embodiment, session broker 126 may indicate that one of client devices 102(a-n) may connect to terminal server 112. The redirector 122 feeds a packet 116 to one of client devices 102(a-n) containing a redirection token 128, indicating an IP address of the virtual desktop. Also the redirector 122 sends an indication of connection to one of client devices 102(a-n), but, in one embodiment, does not expose the IP address of the virtual desktop that the client device is connected. In this embodiment, the re-director maintains a list of the names of the virtual desktops indicated by each of the client devices 102(a-n) and the corresponding IP address of the virtual desktop 118. Thus when a connection name is provided with the request, the re-director 122 establishes a connection between one of the client devices 102(a-n) with the corresponding virtual desktop 118. In another embodiment, redirector 108 may supply the IP address of the virtual desktop to the client device 102 so that client device 102 may directly connect to the virtual desktop.

In FIG. 2 there is shown a block diagram 200 illustrating selected modules in one of client devices 102(a-n) (herein referred to as client device 102) of the integration system 100.

The client device 102 has process capabilities and memory suitable to store and execute computer-executable instructions. In this example, client device 102 includes one or more processors 202, memory 204 and is coupled with network interface 212. The memory 204 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 204 are operating system module 206, application(s) 208, and RDP protocol handler module 212. The modules may be implemented as software or computer-executable instructions that are executed by the one or more processors 202.

The operating system module 206 contains an operating system that may enable the other modules of the client device 102 to receive, process, and exchange data. In addition, the operating system module 206 may also enable the client device 102 to communicate with other devices across a network 104 using network interface 212.

In FIG. 3 there is shown a block diagram 300 illustrating selected modules in one of virtual desktops 118(a-n) (herein referred to as virtual desktop 118) of the integration system 100. Virtual desktop 118 may be embedded in a server, for example as a blade, or in one embodiment may be set-up as a process in a server having one or more processors.

The virtual desktop 118 has process capabilities and memory suitable to store and execute computer-executable instructions. In this example, virtual desktop 118 includes one or more processors 302 and memory 304. The memory 304 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 304 are operating system module 306, one or more application(s) 308, and database 312. The modules may be implemented as software or computer-executable instructions that are executed by the one or more processors 302.

The operating system module 306 contains an operating system that may enable the other modules of the virtual desktop 118 to receive, process, and exchange data. In addition, the operating system module 306 may also enable the virtual desktop 302 to communicate with other devices via redirector device 108.

### Exemplary Process

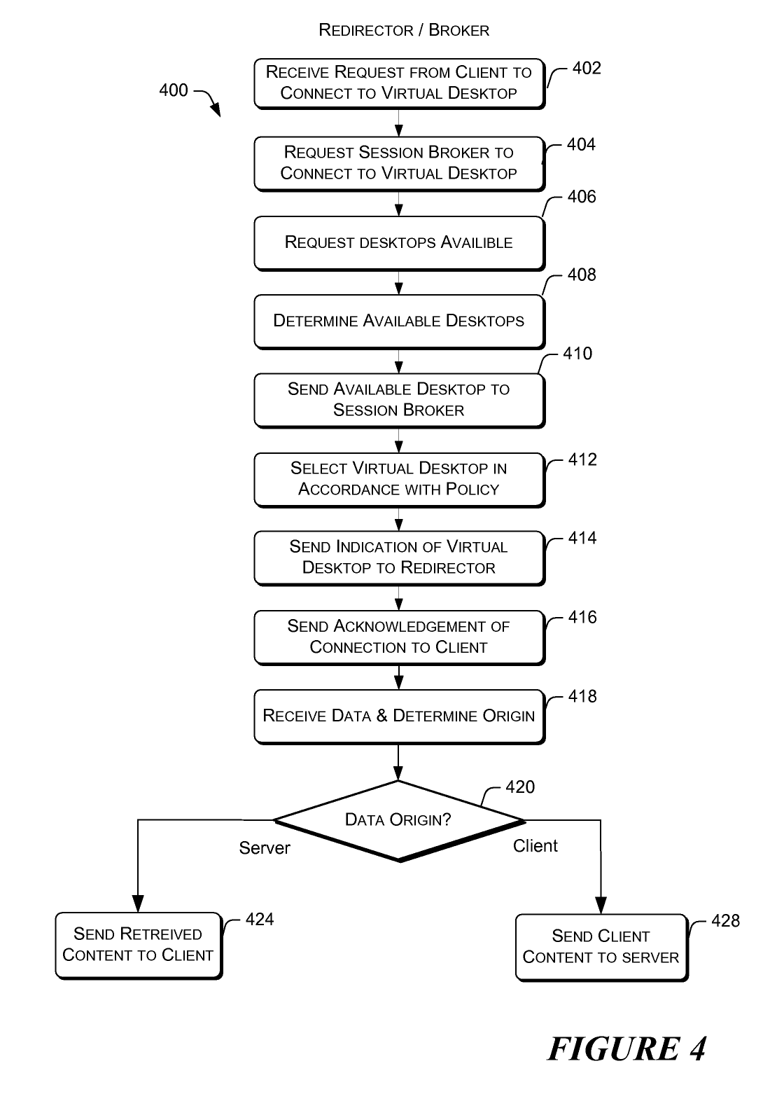

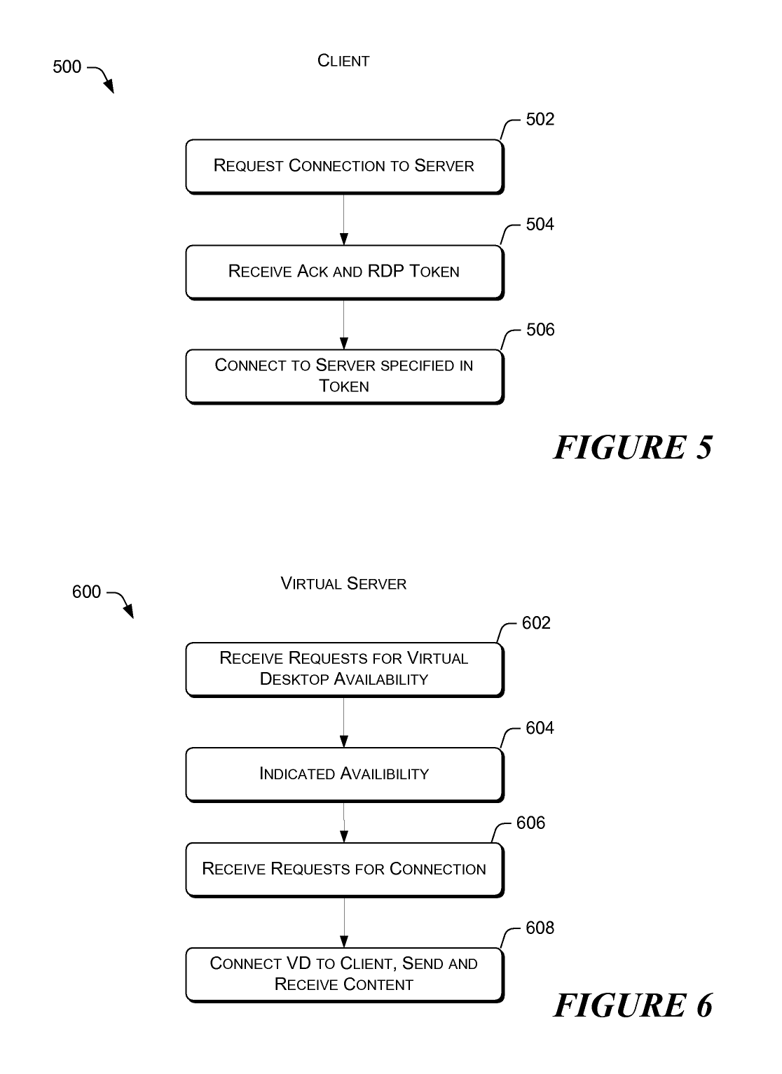

The exemplary processes, shown in FIGS. 4-6, are illustrated as a collection of blocks in a logical flow diagram. The flow diagram in FIG. 4 depicts exemplary processes 402-428 used by processor 118 (see FIG. 1) in redirector device 108 and broker 124 (see FIG. 1), and represents a sequence of operations that can be implemented in hardware, software, and a combination thereof. The flow diagram in FIG. 5 depicts exemplary processes 502-506 used by processor 202 (see FIG. 2) in client device 102 (see FIGS. 1 and 2), and also represents a sequence of operations that can be implemented in hardware, software, and a combination thereof. The flow diagram in FIG. 6 depicts exemplary processes 602-608 used by processor (not shown) in server 110 (see FIG. 1), and additionally represents a sequence of operations that can be implemented in hardware, software, and a combination thereof. In the context of software, the blocks represent computer-executable instructions that, when executed by one or more processors, perform the recited operations.

Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to system 100 of FIG. 1 and system 200 of FIG. 2, although it may be implemented in other system architectures.

FIG. 4 illustrates a flow diagram of an exemplary process 400 used by a redirector device 108 and broker 124 to connect client device 102 with a virtual desktop 118 or terminal server 112. At block 402, a request is received from the client device 102 to connect to one of the virtual desktop 118(a-n). The request may include the name of the requesting client device and a name of the virtual desktop. Such a request is received by the redirector 122 and is sent to session broker 126 in block 404. In block 406, the session broker transmits a request to pool manager 130 requesting available virtual desktops. In block 408, the pool manager 130 determines which virtual desktops 118(a-n) are available, by polling the virtual desktops or by reading a table stored in memory that tracks the virtual desktop availability. In one embodiment, the pool manager 130 may determine that the terminal server 112 is available for transmitting and receiving content. In block 410 pool manager 130 provides a notification of virtual desktop availability to session broker 126.

In block 412, the session broker 126 reads a table in policy module 128 indicating which of the virtual desktops 118(a-n) may be used with a particular client device 102. Such elements of the table may be set by an administrator. In accordance with the table, the virtual desktop 118 is selected and the IP address for the virtual desktop 118 is provided to redirector 122 in block 414. Redirector 122 then stores the IP address and the corresponding name provided by the client device 102. In block 416, a connection is established by feeding an acknowledgment of the connection request to client device 102.

Once the connection is established, in block 418 the redirector device 108 then receives content during a session from either one of the virtual desktops 118(a-n) or one of the client devices 102(a-n). In block 420, the origin of the content is determined. If the content originates from one of the virtual desktops 118(a-n) in server 110, in block 424 the redirector 122 feeds retrieved content to the client device 102 If the content originates from one of the client devices 102(a-n), in block 426 the redirector 122 reads the address for the device originating the content, and feeds the client content using redirector device 108 to the corresponding virtual desktop 118 (or terminal server 112) in block 428.

FIG. 5 illustrates a flow diagram of an exemplary process 500 used by client device 102 to connect via redirector device 108 with a virtual desktop 118 or terminal server 112. At block 502, a request is made by the client device 102 to connect to one of the virtual desktops 118(a-n). In one embodiment, the request may be made by the device 102 to connect with the terminal server 112. In block 504, the client device 102 may receive and acknowledgment that it is connected to the virtual desktop. Once it is connected, client device 102 may start a session by transmitting or receiving data from the virtual desktop 118. In one embodiment, a token may be received from the redirector device 108 in the RDP packet indicating an IP address, or a name of the virtual desktop that the client device 102 is connected. In block 506, the client device may indicate that name or address to redirector device 108 when connecting the virtual desktop 118. In another example, the name or address may correspond to an IP address of terminal server 112.

FIG. 6 illustrates a flow diagram of an exemplary process 600 used by server 110, e.g. a VM host, to initiate a connection to client device 102 via redirector device 108. At block 602, the server 110 receives requests for virtual desktop 118 availability. In block 604, the server 110 polls its virtual desktops, and feeds an availability indication to server 108. In block 606, the server 110 receives requests for connection between one of the virtual desktops 118 and one of the client devices. The request may include the IP address of the requested virtual desktop. In block 608, server 110 indicates that a connection has been established. Further, server 110 both sends content to and receives content from the client device 102.

### Conclusion

In closing, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
connecting a client computer to one of a plurality of virtual desktops operating on a server by examining a redirector token in a remote desktop protocol (RDP) compliant packet, and connecting the client computer to one of the plurality of virtual desktops based on information contained in the redirector token.

2. The method as recited in claim 1 wherein each of the plurality of virtual desktops comprises an operating system that is executed independently of the operating systems of the other virtual desktops.

3. The method as recited in claim 1 further comprising:
transmitting from a redirector module the RDP compliant packet to a client computer, and wherein the redirector token is examined by the client computer and comprises data relating to an address of a location of one of the virtual desktops in the server; and connecting the client computer to the one of the plurality of virtual desktops at the address.

4. The method as recited in claim 3 wherein the redirector module transmits a request to a session broker for the address of one of the virtual desktop to connect to the client computer.

5. The method as recited in claim 4 comprising assigning a policy to the session broker that governs a selection by the session broker of the data relating to the address of the virtual desktop; and requesting by the client computer a connection to one of the plurality of virtual desktops, such that when the client requests the connection the session broker supplies the IP address of the one of the plurality of virtual desktops without revealing the IP address of the virtual desktop to the client computer.

6. The method as recited in claim 5 further comprising receiving with the session broker an indication of available virtual desktop from a pool manager, said pool manager determining which of the virtual desktops are available for connecting to the client computer.

7. The method as recited as recited in claim 6 wherein the redirector, the session broker and the pool manager are disposed in the same server.

8. A computer readable medium comprising computer-executable instructions that, when executed by one or more processors, perform acts comprising:
connecting a client computer to one of a plurality of virtual desktops using a session broker and a pool manager, wherein the session broker assigns one of the plurality of desktops to connect to the client computer, and the pool manager indicates which of the virtual desktops are available to be assigned.

9. The computer readable medium as recited in claim 8, wherein the acts further comprise connecting the client computer to one of a plurality of terminals sessions.

10. The computer readable medium as recited in claim 8, wherein the acts further comprise:
supplying an address to a client computer relating to a location of the virtual desktop;
selecting the address with the session broker; and
assigning a policy to the session broker that governs the selection of the address.

11. The computer readable medium as recited in claim 9 wherein the acts further comprise receiving with the session broker an indication of an availability of one of the plurality of virtual desktops from a pool manager; and determining with said pool manager which of the virtual desktops are available for connecting to the client computer.

12. The computer readable medium as recited as recited in claim 10 wherein the redirector, the session broker and the pool manager are disposed in a same server.

13. A method comprising:
connecting a remote desktop protocol (RDP) client computer to one of a plurality of virtual desktops, said RDP client computer indicating a network name that is used to generate an internet protocol (IP) address to establish a virtual desktop session between the client computer and the one of the plurality of virtual desktops.

14. The method as recited in claim 13 wherein each of the plurality of virtual desktops comprises a processor and an operating system, wherein the processor and operating system execute independently of the processor and operating systems of the other virtual desktops.

15. The method as recited in claim 13 further comprising:
transmitting from a redirector module an RDP compliant packet to the client computer, and wherein the redirector token is examined by the client computer and comprises data relating to an address of a location of one of the virtual desktops; and connecting the client computer to the one of the plurality of virtual desktops at the address.

16. The method as recited in claim 13 wherein the redirector module transmits a request to a session broker for the address of one of the virtual desktops to connect to the client computer.

17. The method as recited in claim 16 comprising assigning a policy to the session broker that governs a selection by the session broker of the data relating to the address of the virtual desktop to be supplied to the client computer.

18. The method as recited in claim 17 further comprising receiving with the session broker an indication of available virtual desktop from a pool manager, said pool manager determining which of the virtual desktops are available for connecting to the client computer.

19. The method as recited as recited in claim 18 wherein the redirector, the session broker and the pool manager are disposed on the same server.

20. The method as recited in claim 13, wherein the IP address is hidden from the client computer.
